(19) United States
(12) Patent Application Publication
(10) Pub. No.: US 2011/0302049 A1
(43) Pub. Date: Dec. 8, 2011

(54) System and method for computer program implemented individual unique candle design

(76) Inventor: Thomas G. Dion, Benicia, CA (US)

(21) Appl. No.: 13/053,159

(22) Filed: Mar. 21, 2011

Related U.S. Application Data
(63) Continuation-in-part of application No. 12/027,265, filed on Feb. 6, 2008, now abandoned.

(51) Int. Cl. G06Q 30/00; G06F 17/50

(52) U.S. Cl. 705/26.5; 700/98

(57) ABSTRACT

A system and method for modeling and implementation of a computer program to provide an individual user or customer, the ability to exercise said user's own individual unique hand generated artistic talents, in each of three planes, in order to create said user's own unique desired three dimensional candle from an infinite number of variations and possibilities, and then order said unique desire for manufacture and delivery through said computer program. Said computer implemented system and method may be implemented on a single stand alone computer, or a computer or computer terminal connected to a private or public network. Said public network may be the World Wide Web based internet.

### CROSS REFERENCE TO RELATED APPLICATIONS

This continuation-in-part application claims priority from applicant's U.S. non-provisional application Ser. No. 12/027,265 filed on Feb. 6, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The system and method described below relates to modeling and implementation of a computer program to provide an individual user with an infinite number of variations to exercise said user's artistic talents to self-create said user's own unique desired candle, and order said unique desire for manufacture and delivery through said on-line internet website.

2. General Background

In the prior art an individual was able to go to a candle store and select from a fixed number of candles on display and then purchase it at the store counter. In addition, an individual was able to select from a printed catalog, and select from a number of displayed candles, and then purchase it by filling out and mailing in an order form. Finally, in recent years, this catalog approach, was placed up on internet websites, thereby similarly allowing an individual to select from an internet on-line printed catalog, and select from a number of displayed candles, and then purchase it by filling out credit or debit card information on-line, and submitting it for approval, then product shipping. However, all of the aforesaid methods, limited an individual user or customer, to those limited number of candle designs that were already designed and selected by other individuals, for display in a store, publishing in a catalog, or displaying on an internet website. None of these approaches allowed an individual to personally design, using said individual's own hand manipulation, using a program implemented on a stand-alone computer or on a computer network (private or public), a unique artistic geometric design for manufacture, payment and delivery, as directed by said individual user.

Accordingly, what is needed is a system and a method implemented by a computer program, through a stand-alone computer or a computer network, which enables an individual to use his or her own unique human artistic talents and actually artistically create an infinite number of variations of three dimensional unique candle designs that overcome the aforesaid deficiencies. This invention solves this problem.

### BRIEF SUMMARY OF THE INVENTION

The system and method disclosed in the preferred embodiment can be implemented on any computer or computer terminal which is connected to a single computer or computer network (private or public), said system and method which will enable an individual to use his or her own unique human artistic talents and actually artistically create an infinite number of three dimensional unique candle designs.

In one embodiment, the system will allow an individual computer program user to select the option of creating his or her own unique candle design. At said user's option, the user is presented with a screen displayed drawing board, said screen being presented to the user three times, once each for the three planes of view thereby creating uniqueness in each of three dimensions simultaneously and a unique 3-D candle object, and wherein said user utilizes his or her own hand manipulated mouse or similar individually operated computer program input device to draw any geometric design pattern that said user could envision. The user then clicks on said mouse or other similar device to electronically submit or transmit his or her personally drawn three designs (one in each plane; i.e. plan, section and elevation), and then said user is given further options by said computer program to optionally select, for each of the three planes' designs which when taken together make up the final three dimensional candle: wax types, wax colors, wick colors, wick types and different scents for his uniquely designed geometric candle shape. Finally, the user can pay for said user's uniquely designed candle with credit cards, debit cards. account. The candle is then manufactured and shipped to said user's requested shipping address. The system provides a solution to the problems associated with selection of catalog-like fixed selections of candle variations, and allows a user to self-create an infinite number of candle geometric design permutations.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1 is a block is a block diagram of the sequential process that an individual would effect in practicing one embodiment of the invention.

FIG. 2 is an exemplary illustration of the display of the first and opening page of the computer program.

FIG. 3 is an exemplary illustration of the display of the second user selected page of the computer program.

FIG. 4 is an exemplary illustration of the display of the third user selected page of the computer program.

FIG. 5 is an exemplary illustration of the display of the fourth user selected page of the computer program.

FIG. 5A is a continuation of FIG. 5 which is an exemplary illustration of the display of the fourth user selected page of the computer program, said page being shown to the user two more times, so as to allow the user to create a unique hand drawn design, in each of three planes.

FIG. 6 is an exemplary illustration of the display of the fifth user selected page of the computer program.

FIG. 7 is an exemplary illustration of the display of the sixth user selected page of the computer program.

FIG. 7A is a continuation of FIG. 7 which is an exemplary illustration of the display of the sixth user selected page of the computer program.

FIG. 8 is an exemplary illustration of the display of the seventh user selected page of the computer program.

FIG. 9 is an exemplary illustration of the display of the eighth user selected page of the internet based computer program.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

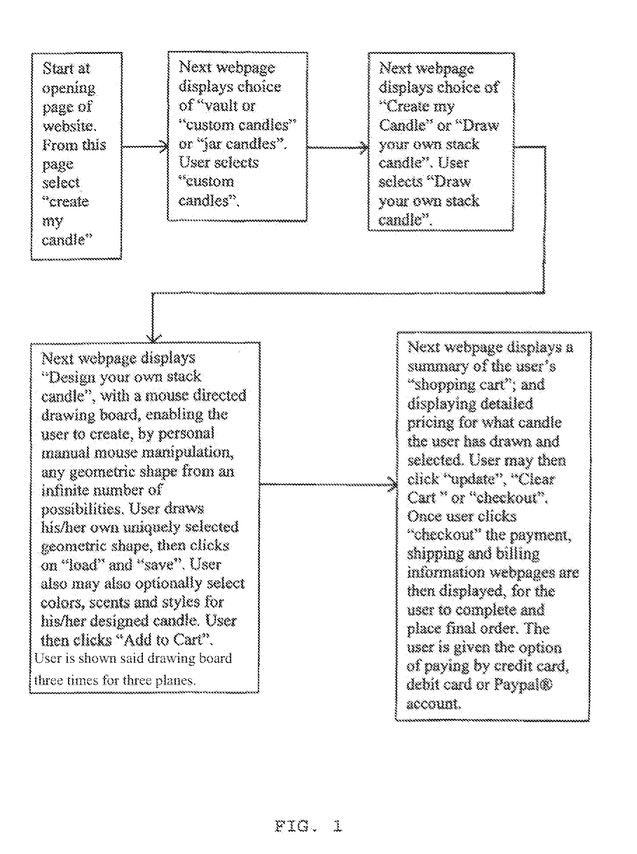

Reference will now be made in detail to an exemplary embodiment of the system, an example which is illustrated in the accompanying drawing (FIGS. 1-9).

FIG. 1 is a block diagram of the sequential process that an individual would effect in practicing one embodiment of the invention. It describes the logical sequence that an individual user or customer would encounter in the process of proceeding through the computer program appearing on a website, in order for said user or customer to uniquely design his or her own candle according to his or her own desires and individual artistic talents from an infinite number of possibilities.

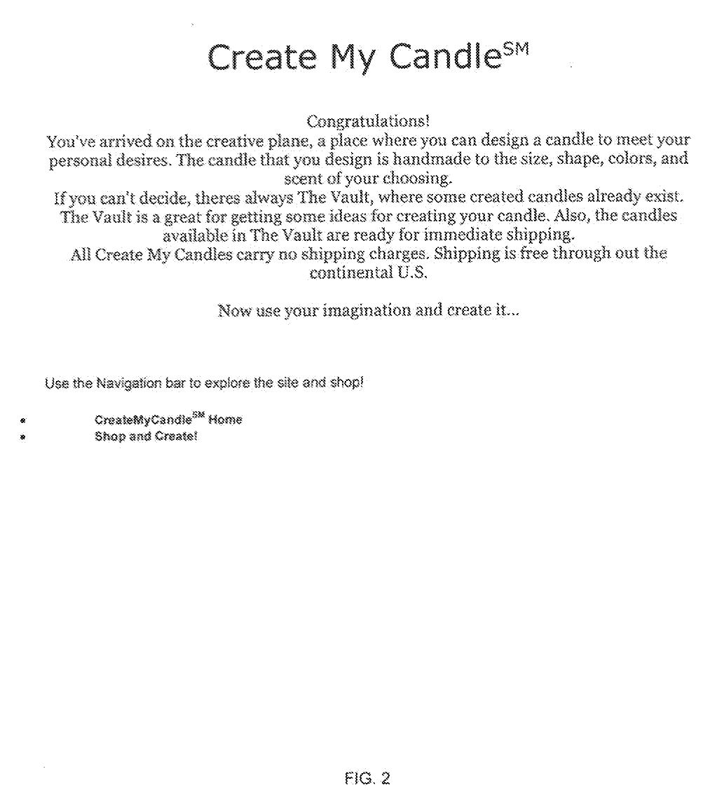

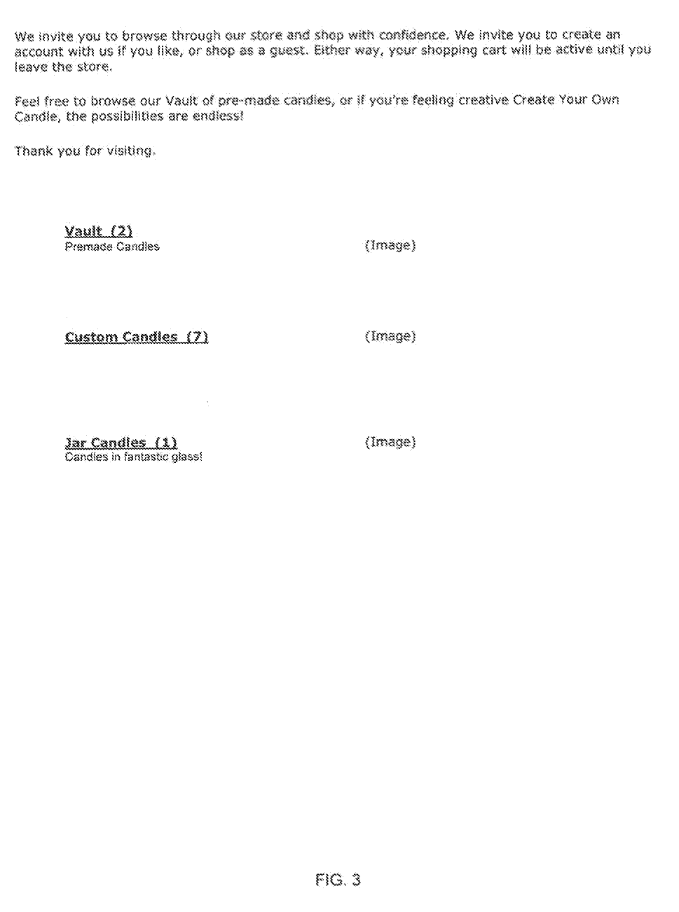

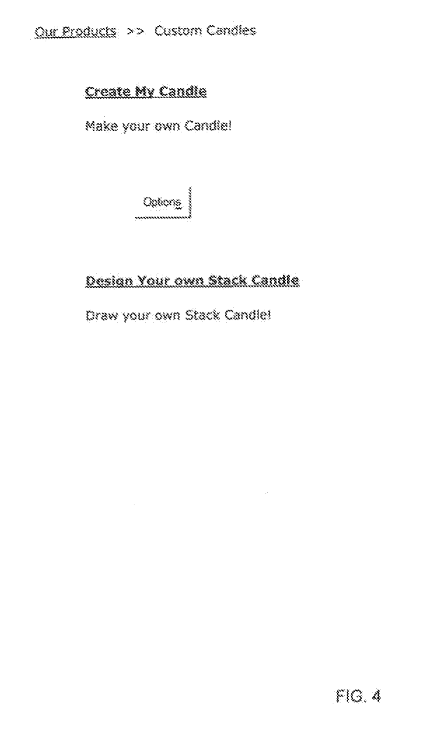

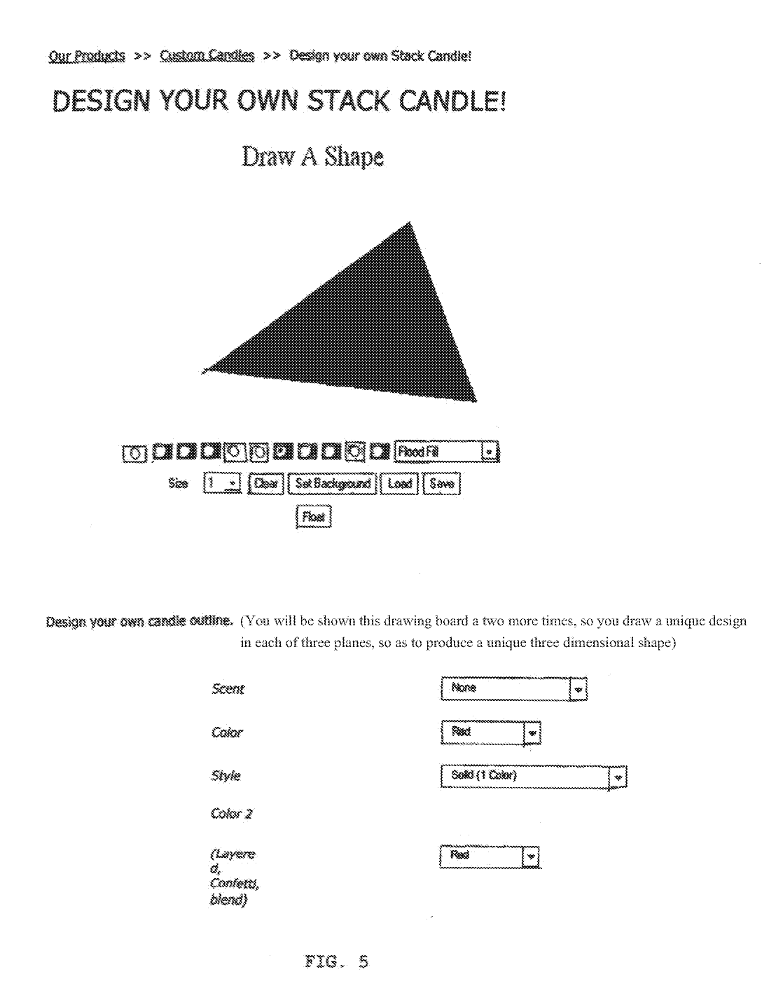

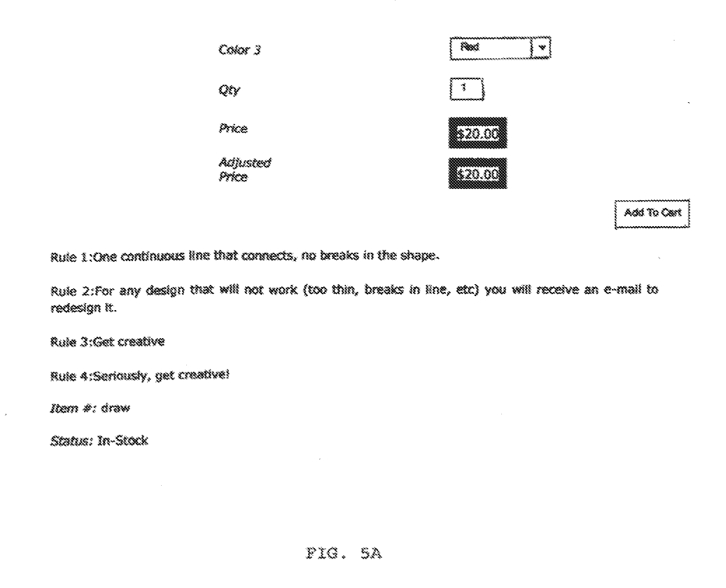

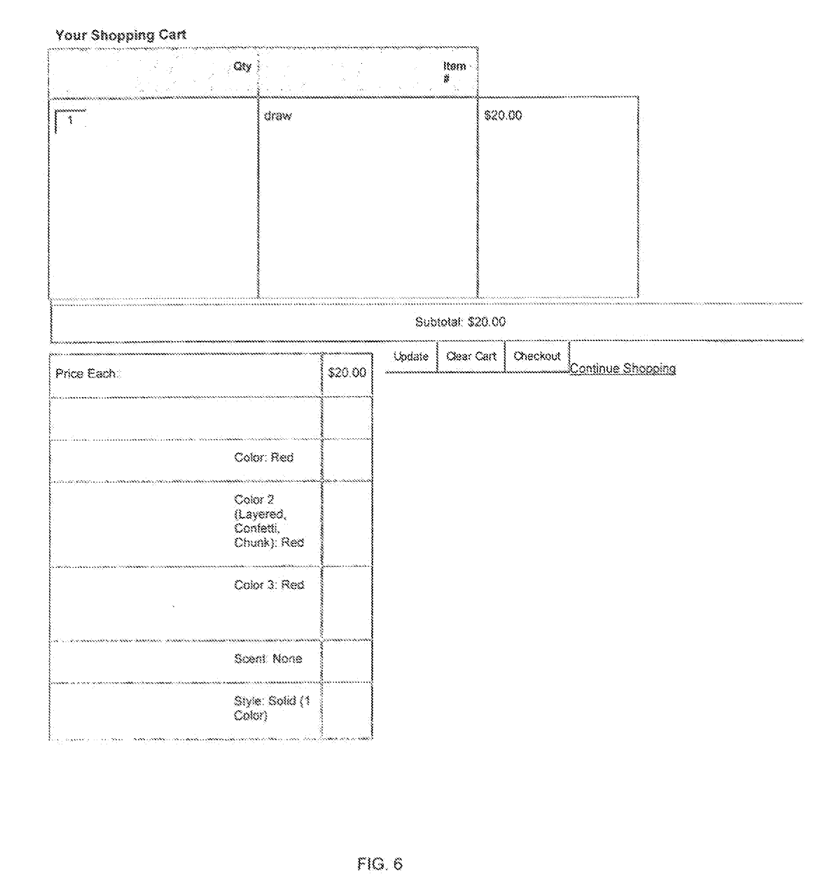

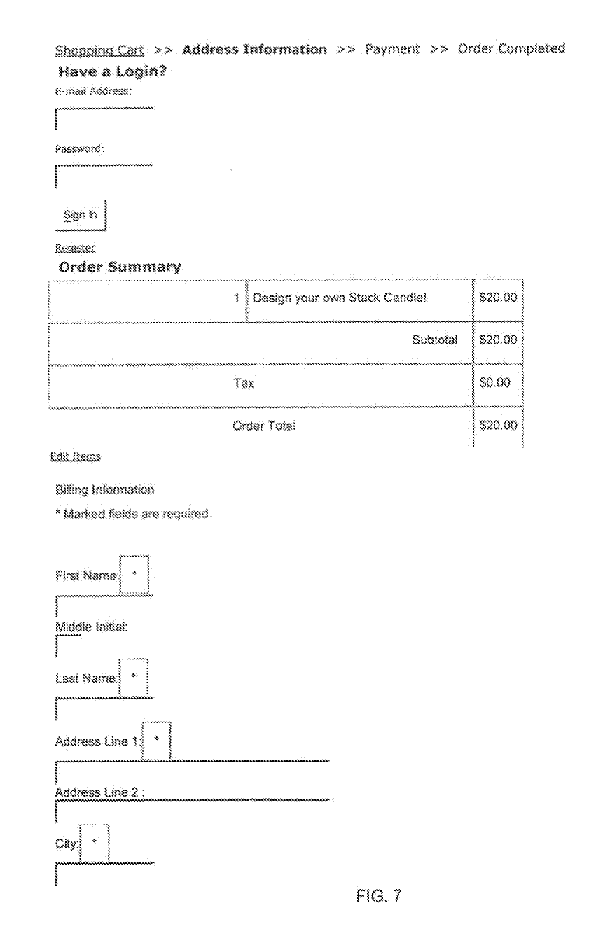

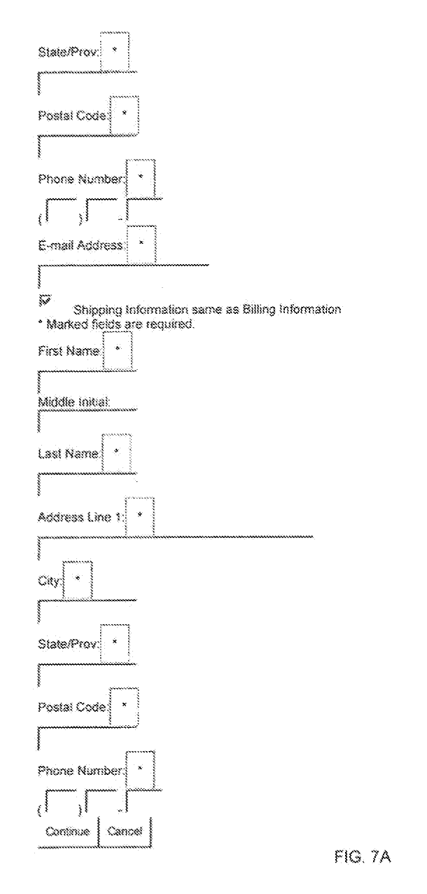

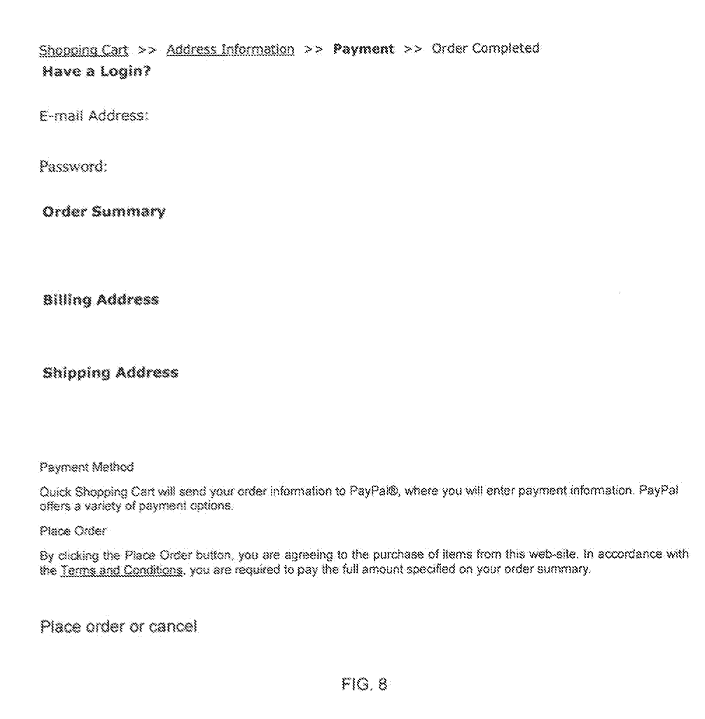

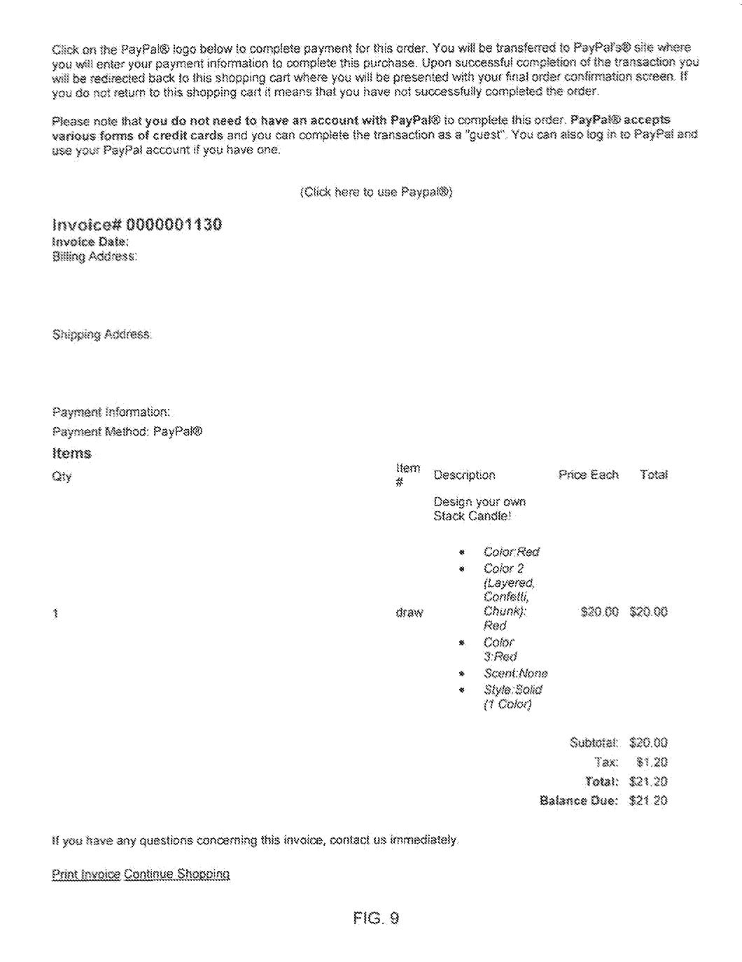

A user or customer would enter a website, obtained by knowing the domain name or by obtaining said domain name through a search engine, and said user or customer would start at the opening page of website depicted by FIG. 2. From this page, the user would select “create my candle”, and using the computer mouse, the user would click on said webpage choice. The next webpage, depicted by FIG. 3 would be displayed to the user, which page displays the choice of “vault or “custom candles” or “jar candles”. The user would select “custom candles”. The next webpage, depicted by FIG. 4 would be displayed to the user, which page displays the choice of “Create my Candle” or “Draw your own stack candle”. The user would select “Draw your own stack candle”. The next webpage, depicted by FIG. 5 and FIG. 5A, would be displayed to the user, which page displays “Design your own stack candle”, with a user manually manipulated mouse directed drawing board or other similar device, enabling the user to create, by personal manual mouse manipulation or other similar device, any geometric shape from an infinite number of possibilities. The user is able to draw his/her own uniquely selected geometric shape, and then said user would click on “load” and “save”. The user also may also optionally select colors, scents and styles for his/her designed candle. When said user decides he or she is satisfied with his or her own unique design, the user is then shown the aforesaid drawing page two more times, with the user again, generating a user hand drawn unique design for each of three planes, namely section, election and plan, or X-Y plane, Y-Z plane and X-Z plane. Once the user completes each of the three personally hand drawn planes, said user would then select “Add to Cart”. The next webpage, depicted by FIG. 6, displays a summary of the user's “shopping cart”; and displaying detailed pricing for what candle the user has drawn and selected. The user may then select “update”, “Clear Cart” or “checkout”. Once user clicks “checkout”, the order summary, payment, shipping and billing information WebPages are then displayed, depicted by FIG. 7, FIG. 7A, and FIG. 8, for the user to complete and place final order. The user then selects “Place Order”, wherein the next and final webpage is displayed, depicted by FIG. 9, which webpage gives the user is given the option of paying by credit card, debit card. account, to finally submit the order for processing, manufacture and delivery as proscribed by the user.

Another embodiment allows an individual user to use a single computer, not network connected, to practice the aforementioned system and method of this invention. Another embodiment allows an individual user to use a computer or computer terminal connected to a private network to practice the aforementioned system and method of this invention.

Another embodiment includes the option of the ability for the individual user's computer transmitted unique geometric candle design being directly further transmitted directly to a microprocessor based automated computer controlled CNC-type (computer-numerical-controlled) machine for direct manufacture of said individual user's unique design.

Another embodiment includes the options of the user selecting differing wax types, wax colors, scents, wick colors, wick designs and use of a mouse or joystick for the individual user to self-create said user's own unique artistic geometric candle design.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method implemented by a computer program running on a computer, the method comprising: an individual user entering the opening display page of said computer program, said opening page providing said user the option of deciding to create said user's own unique hand generated unique candle design, said user choosing to create said individual's own unique self-generated candle design, said user then being given the ability to personally manually self-generate a unique geometric design for said candle, from an infinite number of possibilities, said user personally manipulating an electronic input device to said computer program and drawing said user's own uniquely selected geometric shape, said individual then again drawing a unique design in a second plane, said individual then again drawing a unique design in a third plane thereby creating in the when all of said three planer designs are taken together a unique three dimensional candle design, said user then transmitting said unique three dimensional candle geometric design via said computer program for manufacture of said unique candle design.

2. A method according to claim 1, wherein said computer program is running on a single stand alone computer.

3. A method according to claim 1, wherein said computer program is running on a private computer network.

4. A method according to claim 1, wherein said computer program is running on a world wide web based internet public computer network.

5. A method according to claim 1, wherein said computer program provides pricing information to said user.

6. A method according to claim 1, wherein said computer program transmits payment, billing and shipping information through said computer program for delivery of said unique candle design.

7. The method according to claim 1, wherein said individual user may also select from a plurality of wax colors for his or her individual manually generated unique geometric candle design.

8. The method according to claim 1, wherein said individual user may also select from a plurality of scents for his or her individual manually generated unique geometric candle design.

9. The method according to claim 1, wherein said individual user draws his or her own manually generated unique design using a hand held computer mouse device.

10. The method according to claim 1, wherein said individual user draws his or her own manually generated unique design using a hand held computer joystick lever device.

11. The method according to claim 1, wherein the individual user may also select the use of from a plurality of wax types for said individual user's unique candle design.

12. The method according to claim 1, wherein the individual user may also select the use of from a plurality of wick colors for said individual user's unique candle design.

13. The method according to claim 1, wherein the individual user may also select the use of from a plurality of wick designs for said individual user's unique candle design.

14. The method according to claim 1, further comprising the ability of the individual user selecting from a plurality of wax colors, plurality of scents, plurality of wax types, plurality of wick colors and plurality of wick designs, all in a single computer program transmitted order.

15. The method according to claim 1, further comprising the ability for the individual user's computer transmitted unique geometric candle design being further transmitted directly to a microprocessor based computer controlled CNC-type machine for manufacture of said individual user's unique design.

16. The method according to claim 14, further comprising the ability for the individual user's computer transmitted unique geometric candle design being further transmitted directly to a microprocessor based computer controlled CNC-type machine for manufacture of said individual user's unique design.
